(19) United States
(12) Patent Application Publication
(10) Pub. No.: US 2014/0168829 A1
(43) Pub. Date: Jun. 19, 2014

(54) Gate Drive Circuits that Control Electromagnetic Interference and Switching Losses and Related Methods

(71) Applicant: EATON CORPORATION, Cleveland, OH (US)

(72) Inventor: Robert William Johnson, JR., Raleigh, NC (US)

(73) Assignee: Eaton Corporation, Cleveland, OH (US)

(21) Appl. No.: 13/717,927

(22) Filed: Dec. 18, 2012

(51) Int. Cl. H02H 9/00; H02H 9/02

(52) U.S. Cl. CPC H02H 9/00; H02H 9/02
USPC 361/42; 361/88

(57) ABSTRACT

Gate drive circuits for use with semiconductor switching devices are provided. The gate drive circuits include a gate resistor of the semiconductor switching device; a resistance control module in series with the gate resistor of the semiconductor switching device, the resistance control module being configured to provide a first resistance that controls electromagnetic interference under normal operating conditions; and a second resistance during abnormal events; and an abnormal event detector coupled to the resistance control module, the abnormal event detector configured to detect an abnormal event and send an abnormal event signal to the resistance control module responsive to detection of the abnormal event. The resistance control module is configured to provide the second resistance by shorting the resistance provided by the resistance control module responsive to the abnormal event signal to provide increased gate drive and reduced switching losses during the abnormal event.

### FIELD

The inventive concept relates to drive circuits for semiconductor devices and, more particularly, to gate drive circuits.

### BACKGROUND

Semiconductor switching devices, such as metal oxide semiconductor field effect transistors (MOSFETs) and insulated gate bipolar transistors (IGBTs), are commonly used in power supply devices, such as switchmode power supplies, uninterruptible power supplies (UPSs), motor drives and the like. At certain power levels and switching frequencies, the power dissipated by such switching devices may represent a large portion of overall system losses, especially under abnormal loading conditions. There are a variety of different techniques used to drive MOSFETs, IGBTs and similar devices.

Conventional gate drive circuits typically have different turn on and turn off drives. In other words, driving a gate of a semiconductor switching device typically consists of applying different drive levels to turn on the device and to turn off the device. The high rate of change of the current (i) (di/dt) from the diode recovery or the high rate of change of the voltage (v) (dv/dt) from the switch of the centerpoint of the half leg converter can cause electromagnetic interference (EMI). As used herein, “EMI” refers to any undesirable electromagnetic emission or any electrical or electronic disturbance, man-made or natural, which causes an undesirable response, malfunctioning or degradation in the performance of electrical equipment.

Thus, to address the problems associated with fast switching speeds, the gate drive circuit is typically adjusted to slow down the turn on transition to reduce the likelihood of causing EMI. For example, as illustrated in FIG. 1, a diode D1 and a resistor R2 may be inserted into the drive circuit in parallel with the gate resistor R1 The addition of the diode D1 and the resistor R2 in parallel with the gate resistor R1 may allow gate current to be different in one direction (turn on) than the opposite direction (turn off), which helps to control the EMI and voltage spike issues. In other words, the possibly of EMI and voltage spikes may be reduced by sacrificing higher dissipation in the semiconductor switching devices due to slower switching speeds. The increased dissipation in the semiconductor switching devices to lower the EMI may cause a problem in overload or short circuit operations due to elevated semiconductor chip/die temperatures. This may require additional semiconductors to support the required current level or a reduction of current level that can be safely supported.

### SUMMARY

Some embodiments of the inventive concept gate drive circuits for use with semiconductor switching devices including a gate resistor of the semiconductor switching device; a resistance control module in series with the gate resistor of the semiconductor switching device, the resistance control module being configured to provide a first resistance that controls electromagnetic interference under normal operating conditions; and a second resistance during abnormal events; and an abnormal event detector coupled to the resistance control module, the abnormal event detector configured to detect an abnormal event and send an abnormal event signal to the resistance control module responsive to detection of the abnormal event. The resistance control module is configured to provide the second resistance by shorting the resistance provided by the resistance control module responsive to the abnormal event signal to provide increased gate drive and reduced switching losses during the abnormal event.

In further embodiments, the resistance control module may be a resistor in series with the gate resistor and coupled to the semiconductor switching device and have a value set to control electromagnetic interference.

In still further embodiments, the abnormal event detector may be configured to send an event over signal after termination of the abnormal event. The resistance control module may be configured to resume normal operation by providing the first resistance that controls electromagnetic interference responsive to the event over signal.

In some embodiments, the resistance control module may be configured to resume normal operation by providing the first resistance that controls electromagnetic interference after expiration of a predetermined period of time. In certain embodiments, the predetermined period of time may be no greater than about ½ a second.

In further embodiments, the semiconductor switching device may be one of a metal oxide semiconductor field effect transistor (MOSFET) and insulated gate bipolar transistors (IGBT).

In still further embodiments, the abnormal event may be one of a short circuit or a system overload.

Some embodiments of the present inventive concept provide, gate drive circuits for use with a semiconductor switching device including a gate resistor of the semiconductor switching device; a resistor in series with the gate resistor of the semiconductor switching device, the resistor having a first resistance that controls electromagnetic interference under normal operating conditions; and a second resistance during abnormal events; and an abnormal event detector coupled to the resistor control module, the abnormal event detector configured to detect an abnormal event and send an abnormal event signal to the resistor control module responsive to detection of the abnormal event. The resistor control module shorts the resistor responsive to the abnormal event signal to provide increased gate drive and reduced switching losses during the abnormal event.

Further embodiments provide methods of driving a semiconductor switching device including detecting an abnormal event; sending an abnormal event signal to a resistance control module responsive to detection of the abnormal event; and shorting a resistance provided by the resistance control module responsive to the abnormal event signal to provide increased gate drive and reduced switching losses during the abnormal event.

In still further embodiments, the resistance control module may include a resistor in series with the gate resistor and coupled to the semiconductor switching device; and detecting an abnormal event may include providing the resistor with a resistance configured to control electromagnetic interference under normal operating conditions.

In some embodiments, shorting may be followed by determining that the abnormal event has terminated; sending an event over signal after termination of the abnormal event; and providing a resistance at the resistance control module that controls electromagnetic interference responsive to the event over signal.

In further embodiments, the method may further include resuming normal operation at the resistance control module by providing a resistance that controls electromagnetic interference after expiration of a predetermined period of time.

In still further embodiments, detecting an abnormal event may be preceded by providing a resistance at the resistance control module that is configured to control electromagnetic interference during normal operating conditions.

### BRIEF DESCRIPTION OF THE DRAWINGS

FIG. 1 is a circuit diagram of a conventional gate drive circuit.

FIG. 2 is a diagram of a gate drive circuit in accordance with some embodiments of the inventive concept.

FIG. 3A is a diagram of a gate drive circuit in accordance with some embodiments of the present inventive concept.

FIG. 3B is a diagram of a gate drive circuit during an abnormal event in accordance with some embodiments of the present inventive concept.

FIG. 4 is a flowchart illustrating operations of gate drive circuits in accordance with some embodiments of the present inventive concept.

### DETAILED DESCRIPTION OF EMBODIMENTS

The inventive concept now will be described more fully hereinafter with reference to the accompanying drawings, in which illustrative embodiments of the inventive concept are shown. In the drawings, the relative sizes of regions or features may be exaggerated for clarity. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

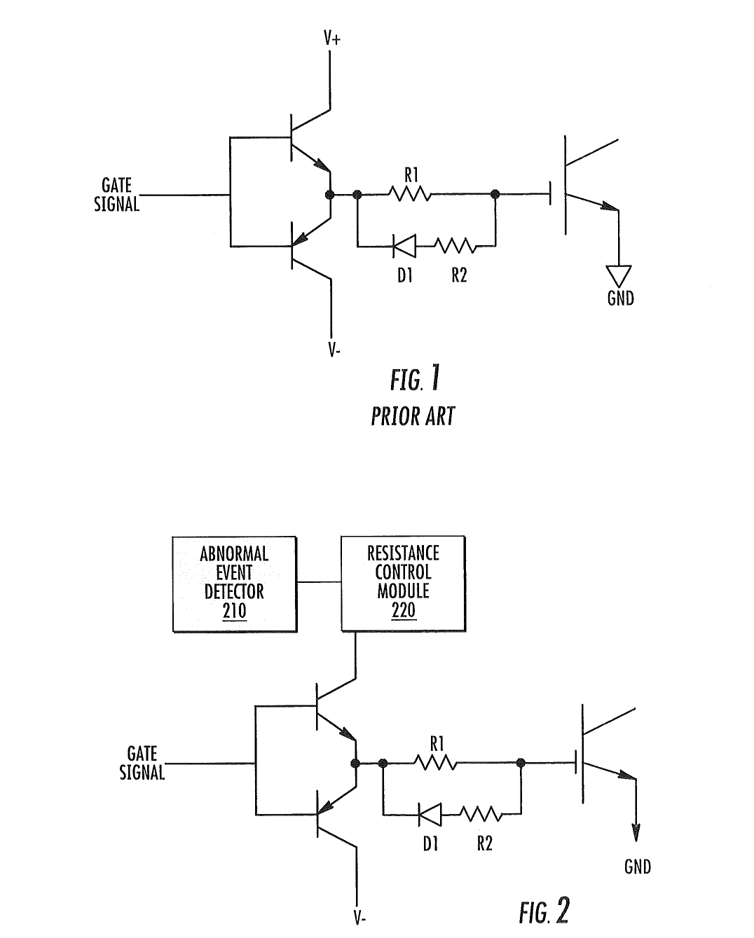

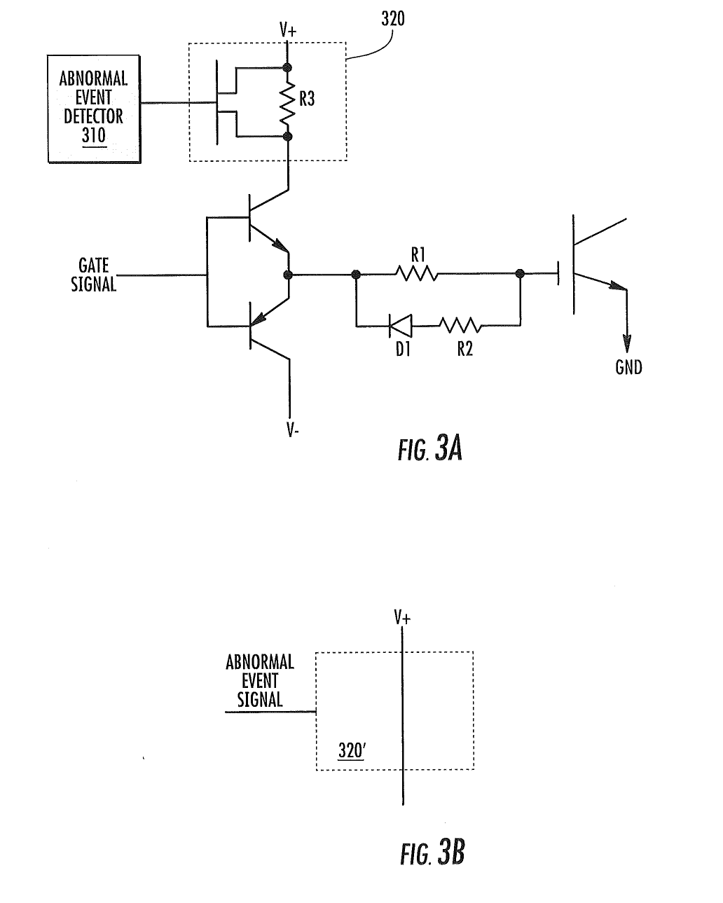

As discussed above, convention gate drive circuits sacrifice switching speed in order to control EMI and voltage spikes. During operation, electronic devices must be designed to compensate for the unexpected or abnormal event. For example, electronic devices are typically designed to withstand short circuits and system overloads. During these events, the semiconductor device experiences very high currents that need to be switched. The resultant dissipation in the semiconductor may cause the temperature of the semiconductor chip/die to increase to levels that may cause damage. Thus, the system is designed such that these damaging semiconductor temperatures will not be reached. However, designing a device to compensate for EMI by definition sacrifices switching speed. In particular, the switching losses can be about five times higher between a gate resistor configured to produce minimum switching losses (i.e. high switching speeds) and a gate resistor that reduces/minimizes EMI. Accordingly, some embodiments of the present inventive concept provide gate drive circuits configured to both control EMI and voltage spikes as well as provide minimum switching losses as will be discussed with respect to FIGS. 2-5 below.

Referring first to FIG. 2, a gate drive circuit in accordance with some embodiments is similar to the gate drive circuit discussed with respect to FIG. 1, but includes an abnormal event detector 210 and a resistance control module 220 connected to the insulated gate bipolar transistors (IGBT) as illustrated in FIG. 2. Although embodiments of the present inventive concept will be discussed herein with respect to IGBTs, it will be understood that embodiments of the present inventive concept are not limited to this configuration. For example, embodiments discussed herein can be used in combination with other semiconductor switching devices, for example, MOSFETs, without departing from the scope of the present inventive concept.

As discussed above, semiconductor devices will experience abnormal events, such as short circuits and system overloads. As used herein, an “abnormal event” refers to an electrical event that can affect the functionality of the device. However, such events typically only last for a very short period of time, for example, less than about ¼ a second. Thus, the abnormal event detector 210 is configured to detect such an abnormal event, for example, by detecting a sudden increase current and to send an abnormal event signal to the resistance control module 220. The resistance control module 220 is configured to change to the second resistance value of the gate drive resistor R1 to provide increased gate drive and reduced switching losses during turn on (the event). When the abnormal event is over, the abnormal event detector 210 may send an event over signal to the resistance control module 220. The resistance control module may then be configured to change to the first restance value of R1 in series with R3 to provide a gate drive that reduces the likelihood of EMI. Accordingly, some embodiments of the present inventive concept are configured to identify abnormal events and send a signal that can change the value of the gate drive resistor responsive thereto.

In some embodiments, the abnormal event detector 210 may not send an event over signal. In these embodiments, the resistance control module 220 may be configured to change the resistance of R1 for a predetermined period of time that exceeds the length of the abnormal event, which is typically no greater than about ½ a second.

Typically, only the turn on drive of the gate drive circuit causes significant switching losses. Thus, embodiments of the present inventive concept are directed to a gate drive circuit that modifies the turn on drive. However, it will be understood that embodiments of the present inventive concept can be applied to modifying the turn off drive without departing from the scope of the present inventive concept.

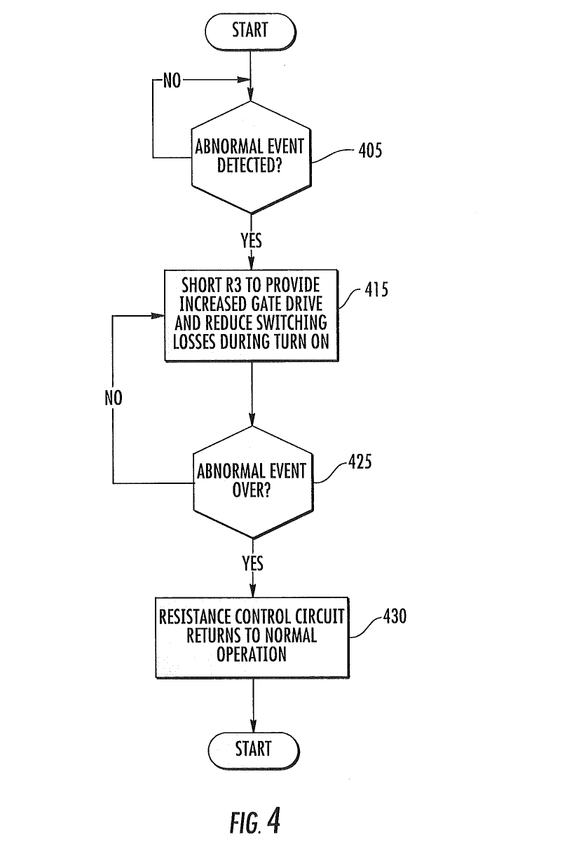

Referring now to FIGS. 3A and 3B, some embodiments of the resistance control module 320 will be discussed. As illustrated in FIG. 3A, the resistance control module 320 includes a resistor R3 in series with R1 for the turn on of the IGBT and is coupled to the abnormal event detector 310. The value of R3 is set to a value that controls EMI under normal functionality, i.e. in absence of an abnormal event. As will be understood by those having skill in the art, these values depend on the specific circuit/device. When an abnormal event is detected by the abnormal event detector 310, it sends the abnormal event signal and R3 is shorted (320′) to provide increased gate drive and reduced switching losses during turn on as illustrated in FIG. 3B. As discussed above, altering the gate resistor is not usually necessary for turn off since switching losses are less sensitive to the value of the gate resistor. However, it will be understood that if there is an advantage to changing the gate resistor value for turn off switching events, a similar alteration could be made in the collector of the PNP transistor as discussed above with respect to the turn on circuit.

Referring now to FIG. 4, operations of a gate drive circuit in accordance with some embodiments of the present inventive concept will now be discussed. Operations begin at block 405 by determining if an abnormal event has been detected. If an abnormal event has not been detected (block 405), the value of the resistor R3 remains the value that controls EMI. If, on the other hand, an abnormal event is detected (block 405), R3 is shorted to provide increased gate drive and reduced switching losses during turn on (block 415). When it is determined that that the abnormal event is over (block 425), R3 returns to normal operation, i.e. is reset to the value of R3 that controls EMI (block 430).

Accordingly, as briefly discussed above, some embodiments of the present inventive concept provide improved gate drive circuits that provide both EMI control and control switching losses.

In the drawings and specification, there have been disclosed exemplary embodiments of the inventive concept. Although specific terms are employed, they are used in a generic and descriptive sense only and not for purposes of limitation, the scope of the inventive concept being defined by the following claims.

That which is claimed:

1. A gate drive circuit for use with a semiconductor switching device, the gate drive circuit comprising:
a gate resistor of the semiconductor switching device;
a resistance control module in series with the gate resistor of the semiconductor switching device, the resistance control module being configured to provide a first resistance that controls electromagnetic interference under normal operating conditions and a second resistance during abnormal events; and
an abnormal event detector coupled to the resistance control module, the abnormal event detector configured to detect an abnormal event and send an abnormal event signal to the resistance control module responsive to detection of the abnormal event,
wherein the resistance control module is configured to provide the second resistance provided by the resistance control module responsive to the abnormal event signal to provide increased gate drive and reduced switching losses during the abnormal event.

2. The gate drive circuit of claim 1, wherein the resistance control module comprises a resistor in series with the gate resistor and coupled to the semiconductor switching device and having a value set to control electromagnetic interference.

3. The gate drive circuit of claim 1:
wherein the abnormal event detector is configured to send an event over signal after termination of the abnormal event; and
wherein the resistance control module is configured to resume normal operation by providing the first resistance that controls electromagnetic interference responsive to the event over signal.

4. The gate drive circuit of claim 1, wherein the resistance control module is configured to resume normal operation by providing the first that controls electromagnetic interference after expiration of a predetermined period of time.

5. The gate drive circuit of claim 4, wherein the predetermined period of time comprises no greater than about ½ a second.

6. The gate drive circuit of claim 1, wherein the semiconductor switching device comprises one of a metal oxide semiconductor field effect transistor (MOSFET) and insulated gate bipolar transistors (IGBT).

7. The gate drive circuit of claim 1, wherein the abnormal event comprises one of a short circuit or a system overload.

8. A gate drive circuit for use with a semiconductor switching device, the gate drive circuit comprising:
a gate resistor of the semiconductor switching device;
a resistor in series with the gate resistor of the semiconductor switching device, the resistor having a first resistance that controls electromagnetic interference under normal operating conditions and a second resistance during abnormal events; and
an abnormal event detector coupled to a resistance control module, the abnormal event detector configured to detect an abnormal event and send an abnormal event signal to the resistance control module responsive to detection of the abnormal event,
wherein the resistance control module is configured to short the resistor responsive to the abnormal event signal to provide increased gate drive and reduced switching losses during the abnormal event.

9. The gate drive circuit of claim 8:
wherein the abnormal event detector is configured to send an event over signal after termination of the abnormal event; and
wherein the resistor is configured to resume normal operation by providing the first resistance that controls electromagnetic interference responsive to the event over signal.

10. The gate drive circuit of claim 8, wherein the resistor is configured to resume normal operation by providing the first resistance that controls electromagnetic interference after expiration of a predetermined period of time.

11. The gate drive circuit of claim 10, wherein the predetermined period of time comprises no greater than about ½ a second.

12. The gate drive circuit of claim 8, wherein the semiconductor switching device comprises one of a metal oxide semiconductor field effect transistor (MOSFET) and insulated gate bipolar transistors (IGBT).

13. The gate drive circuit of claim 8, wherein the abnormal event comprises one of a short circuit or a system overload.

14. A method of driving a semiconductor switching device, the method comprising:
detecting an abnormal event;
sending an abnormal event signal to a resistance control module responsive to detection of the abnormal event; and
shorting a resistance provided by the resistance control module responsive to the abnormal event signal to provide increased gate drive and reduced switching losses during the abnormal event.

15. The method of claim 14, wherein the resistance control module comprises a resistor in series with the gate resistor and coupled to the semiconductor switching device, and wherein detecting an abnormal event comprises providing the resistor with a resistance configured to control electromagnetic interference under normal operating conditions.

16. The method of claim 14, wherein shorting is followed by:
determining that the abnormal event has terminated;
sending an event over signal after termination of the abnormal event; and
providing a resistance at the resistance control module that controls electromagnetic interference responsive to the event over signal.

17. The method of claim 14, further comprising resuming normal operation at the resistance control module by providing a resistance that controls electromagnetic interference after expiration of a predetermined period of time.

18. The method of claim 17, wherein the predetermined period of time comprises no greater than about ½ a second.

19. The method of claim 14, wherein detecting an abnormal event is preceded by providing a resistance at the resistance control module that is configured to control electromagnetic interference during normal operating conditions.

20. The method of claim 14, wherein the semiconductor switching device comprises one of a metal oxide semiconductor field effect transistor (MOSFET) and insulated gate bipolar transistors (IGBT).

21. The method of claim 14, wherein the abnormal event comprises one of a short circuit or a system overload.
